(19) United States
(12) Patent Application Publication
(10) Pub. No.: US 2009/0186592 A1
(43) Pub. Date: Jul. 23, 2009

(54) RADIO RECEIVER AND RECEIVING SEMICONDUCTOR INTEGRATED CIRCUIT

(75) Inventors: Takeshi Ikeda, Tokyo (JP); Hiroshi Miyagi, Yokohama-shi (JP)

Correspondence Address: CONNOLLY BOVE LODGE & HUTZ LLP, 1875 EYE STREET, N.W., SUITE 1100, WASHINGTON, DC, 20006, US

(73) Assignee: NSC CO., LTD., Tokyo (JP)

(21) Appl. No.: 12/352,686

(22) Filed: Jan. 13, 2009

(30) Foreign Application Priority Data
Jan. 17, 2008 (JP) 2008-008434

(51) Int. Cl. H04B 1/16

(52) U.S. Cl. 455/341

(57) ABSTRACT

A first-stage amplifier of an AM receiving circuit is built into an IC 2 as a differential amplifying circuit 3. The differential amplifying circuit 3 is connected to one pad P1 of the IC 2. Then, a high pass filter is configured by connecting a resistor Ra between two input terminals of the differential amplifying circuit 3 and connecting a capacitor Ca between the resistor Ra and ground and in series with the resistor Ra and ground. Thus, the resistor Ra and capacitor Ca integrated into the IC 2 allows hum noise to be removed.

### BACKGROUND OF THE INVENTION

1. Field of the Invention

The present invention relates to a radio receiver and a receiving semiconductor integrated circuit used for the radio receiver, and in particular, to a radio receiver including a filter that removes hum noise induced in an antenna in connection with a commercial power source.

2. Description of the Related Art

FIG. 3 is a diagram showing a configuration of a part of a conventional AM radio receiver. In FIG. 3, an AM radio wave signal received by an AM antenna 11 is supplied to an AM receiving circuit 12 via a coupling capacitor C for direct component cutting. In the AM receiving circuit 12, the AM signal having passed through the coupling capacitor C is amplified by a first-stage amplifier composed of a junction field effect transistor (junction FET) or a MOS transistor (MOSFET) Tr11. The amplified AM signal is output to a mixer section 13 located in the next stage, via a bipolar transistor Tr12.

Circuits (not shown in the drawings) succeeding the mixer section 13 are integrated on a semiconductor chip (IC) 20 obtained by a bipolar process or a CMOS (Complementary Metal Oxide Semiconductor) process. On the other hand, the AM antenna 11, the AM receiving circuit 12, and the coupling capacitor C are configured as external components of the IC 20.

AM broadcasting uses a lower receiving frequency band than FM broadcasting. Thus, low-frequency hum noise often poses a problem. The hum noise is bass noise of 50 to 60 Hz which is mixed in AM broadcasting sounds. An electromagnetic wave is generated in a power supply wire through which an alternating current flows. This induces electric noise in the antenna of the radio receiver. The electric noise flows through a speaker as an electric signal to cause a listener to hear a constant noise.

To removing the hum noise, the conventional receiver includes a coil L connected to the AM antenna 11 and offering a high inductance of several mH to 50 mH. Furthermore, the hum noise always has a constant frequency. Thus, measures are taken to use a filter circuit to attenuate only the relevant frequency (see, for example, Japanese Patent Laid-Open No. 2002-41281). Japanese Patent Laid-Open No. 2002-41281 discloses the use of a high pass filter for removing the hum noise.

### SUMMARY OF THE INVENTION

However, when the coil L is provided as shown in FIG. 3 to remove the hum noise, integrating the coil L, which offers the high inductance, on the IC 20 is difficult. Furthermore, since in the circuit, the coil L precedes the AM receiving circuit 12, which is an external component, integrating the coil L on the IC 20 is also physically difficult. Thus, the coil L needs to be configured as an external component of the IC 20. This disadvantageously hinders miniaturization of the radio receiver. Additionally, the AM antenna 11 is capacitive and may thus disadvantageously resonate with the coil L, resulting in abnormal oscillation.

On the other hand, the hum noise may be removed using the high pass filter as disclosed in Japanese Patent Laid-Open No. 2002-41281. However, since the AM receiving circuit 12 is configured as an external component of the IC 20, the high pass filter also needs to be configured as an external component. This disadvantageously hinders miniaturization of the radio receiver.

The present invention has been made to solve these problems. An object of the present invention is to allow the hum noise to be removed without the need to provide an arrangement for removing the hum noise which is configured as an external component of the IC.

To accomplish the object, the present invention builds the first-stage amplifier of the AM receiving circuit into the integrated circuit as a differential amplifying circuit, and connects the differential amplifying circuit to one pad of the integrated circuit. A high pass filter is configured by connecting a resistor between two input terminals of the differential amplifying circuit and connecting a capacitor between the resistor and ground and in series with the resistor and ground.

In another aspect of the present invention, a coupling capacitor is provided between the AM antenna and the one pad so that the coupling capacitor and the resistor make up another high pass filter.

The present invention configured as described above allows the differential amplifying circuit to be composed of a MOS transistor. Thus, the first-stage amplifier of the AM receiving circuit, which is conventionally an external component of the IC, can be integrated into the IC. Then, the resistor and capacitor integrated into the IC can be configured as a high pass filter on an input side of the differential amplifying circuit. The high pass filter can remove the hum noise. This enables a hum removing filter to be configured without an external component. Consequently, the number of external components of the IC is reduced, allowing the radio receiver to be miniaturized.

According to another feature of the present invention, another high pass filter can be composed of the combination of the coupling capacitor installed as an external component of the IC and resistor integrated into the IC. The high pass filter can remove the hum noise. Thus, the hum removing filter can be configured with only a minimum required number of external components. As a result, the number of external components of the IC is reduced, allowing the radio receiver to be miniaturized.

### BRIEF DESCRIPTION OF THE DRAWINGS

FIG. 1 is a diagram showing an example of a configuration of a part of a radio receiver using a receiving semiconductor integrated circuit according to the present embodiment;

FIG. 2 is a diagram showing an example of a configuration of a part of the radio receiver using the receiving semiconductor integrated circuit according to the present embodiment; and

FIG. 3 is a diagram showing an example of a configuration of a part of a conventional radio receiver.

### DETAILED DESCRIPTION OF THE PREFERRED EMBODIMENTS

An embodiment of the present invention will be described below with reference to the drawings. FIG. 1 is a diagram showing an example of a configuration of a part of a radio receiver using a receiving semiconductor integrated circuit according to the present embodiment. As shown in FIG. 1, the radio receiver according to the present embodiment includes an AM antenna 1 that receives an AM electric wave, a receiving semiconductor integrated circuit (IC) 2, and a coupling capacitor C connected between the AM antenna 1 and one pad P1 of the IC 2. The IC 2 is a semiconductor chip configured by a CMOS process.

The AM antenna 1 is externally connected to the pad P1 of the IC 2 via the coupling capacitor C. The coupling capacitor C has a function of cutting a direct current component of an AM signal received by the AM antenna 1. A differential amplifying circuit 3 integrated into the IC 2 is internally connected to the pad P1. The differential amplifying circuit 3 differentially amplifies the AM radio wave signal received by the AM antenna 1 and fed via the coupling capacitor C. The AM signal amplified by the differential amplifying circuit 3 is output to a mixer section 4 located in the next stage.

Moreover, a resistor Ra is connected between two input terminals of the differential amplifying circuit 3. A capacitor Ca is connected between the resistor Ra and ground and in series with the resistor Ra and ground. The resistor Ra and the capacitor Ca make up a first high pass filter. Furthermore, the resistor Ra and the coupling capacitor C make up a second high pass filter. Values for the resistor Ra and the capacitors C and Ca are determined such that the first and second high pass filters offer such frequency characteristics as attenuate at least the frequency band (50 to 60 Hz) of a commercial power source, while passing an AM frequency band (about 500 to about 1,700 kHz) without attenuation.

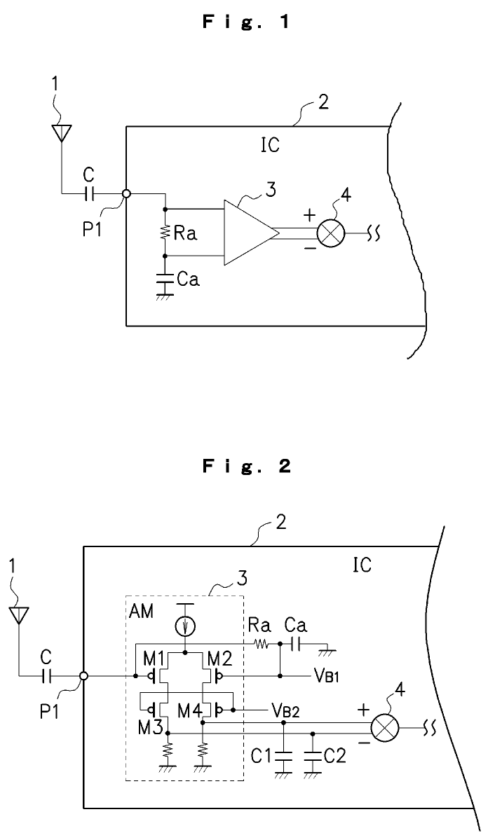

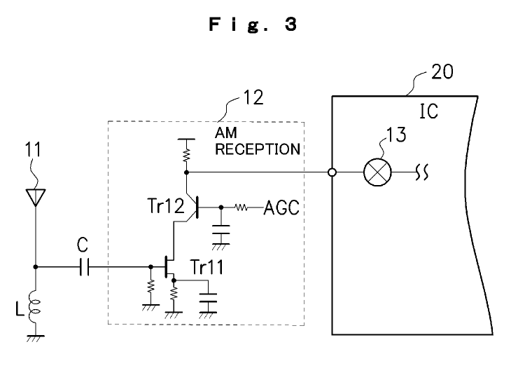

FIG. 2 is a diagram showing a more detailed circuit configuration of the receiving amplifying circuit 2 shown in FIG. 1. As shown in FIG. 2, the differential amplifying circuit 3 includes four pMOS transistors M1 to M4. The pMOS transistors M1 and M2 make up an input differential amplifying pair. The AM radio wave signal received by the AM antenna 1 is input to the pMOS transistor M1. A signal of a bias voltage VB1 is input to the pMOS transistor M2. The pMOS transistors M3 and M4 make up a differential amplifying pair. A signal of a bias voltage VB2 is input to both the pMOS transistors M3 and M4. The bias voltage VB2 can be used as a fixed bias or a variable bias based on AGC (Automatic Gain Control).

Capacitors C1 and C2 serving as a low pass filter are connected to two differential output wires extending from the differential amplifying circuit 3 and connected to the mixer section 4. The low pass filter, made up of the capacitors C1 and C2, is set to offer such frequency characteristics as rapidly attenuate signals of at least the AM frequency band.

As described above, the first high pass filter, made up of the resistor Ra and the capacitor Ca, is connected to the input differential pair M1 and M2 of the differential amplifying circuit 3. The first high pass filter is set to offer frequency characteristics such that a low frequency region of at most 50 to 60 Hz is attenuated to at most a predetermined level by appropriately setting the resistance value of the resistor Ra and the capacitance value of the capacitor Ca. The first high pass filter functions as a hum removal filter that removes hum noise resulting from electromagnetic induction.

Furthermore, as described above, the resistor Ra, integrated into the IC 2, and the coupling capacitor C, externally connected to the IC 2, make up the second high pass filter. Based on the combination of the resistance value of the resistor Ra and the capacitance value of the coupling capacitor C, the second high pass also filter functions as a hum removal filter that removes the hum noise by attenuating the low frequency region of at most 50 to 60 Hz to at most the predetermined level.

The present embodiment is configured in two stages including the first and second high pass filters. This enables an increase in the amount of signal attenuation in the low frequency region of at most 50 to 60 Hz. If the capacitance value of the capacitor Ca is different from that of the coupling capacitor C, the amount of signal attenuation in the low frequency region of at most 50 to 60 Hz varies between the first high pass filter and the second high pass filter.

As described above in detail, in the present embodiment, the first-stage amplifier of the AM receiving circuit is integrated into the IC 2 as the differential amplifying circuit 3. The differential amplifying circuit 3 is connected to the pad P1 to which the AM antenna 1 is connected via the coupling capacitor C. Moreover, the resistor Ra is connected between the two input terminals of the differential amplifying circuit 3 so that the combination of the resistor Ra with the coupling capacitor C makes up the second high pass filter. The capacitor Ca is connected between the resistor Ra and ground and in series with the resistor Ra and ground so as to make up the first high pass filter.

According to the radio receiver according to the present embodiment configured as described above, the differential amplifying circuit 3 can be composed of a MOS transistor, similarly to the circuits succeeding the mixer section 4. Thus, the first-stage amplifier of the AM receiving circuit, which is conventionally an external component of the IC 20, can be integrated into the IC 2 as shown in FIG. 1.

The differential amplifying circuit 3 is integrated into the IC 2. Then, the resistor Ra and capacitor Ca integrated into the IC 2 can be configured as the first high pass filter on the input side of the differential amplifying circuit 3. Moreover, the second high pass filter can be composed of the combination of the coupling capacitor C, installed as an external component of the IC 2, and the resistor Ra, integrated into the IC 2. The first and second high pass filters allow the hum noise to be removed.

Thus, the hum removal filter can be configured with only the minimum required number of external components. That is, the hum removal filter can be configured by eliminating all the external components except the coupling capacitor C, which is conventionally used as an external component. This sharply reduces the number of external components of the IC 2 compared to the conventional technique, allowing the radio receiver to be miniaturized.

In the above-described embodiment, by way of example, the two-stage configuration with the first and second high pass filters is obtained by integrating the resistor Ra and the capacitor Ca into the IC 2. However, the present invention is not limited to this aspect. For example, the filter may have a one-stage configuration with only the first high pass filter made up of the resistor Ra and the capacitor Ca and with the coupling capacitor C omitted. In this case, the hum noise can be removed without an external component simply by configuring the high pass filter made up of the resistor Ra and the capacitor Ca, inside the IC 2. Alternatively, the filter may have a one-stage configuration with only the second high pass filter made up of the coupling capacitor Ca and the resistor Ra and with the capacitor Ca omitted. In this case, the hum removal filter can be configured with only the minimum required number of external components.

Furthermore, in the above-described embodiment, the coupling capacitor is configured as an external component of the IC 2. However, the coupling capacitor may be integrated into the IC 2.

Furthermore, only the AM receiving circuit is illustrated. However, the present invention is also applicable to the AM receiving circuit in a radio receiver (a radio receiver used for both AM and FM) including an FM receiving circuit.

Additionally, the above-described embodiments only show an example of implementation of the present invention, and are not intended to limitedly interpret the technical scope of the present invention. That is, the present invention can be implemented in various forms without departing from the spirits or main features thereof.

This application is based on Japanese Patent Application No. 2008-008434 filed on Jan. 17, 2008, the contents of which are incorporated hereinto by reference.

What is claimed is:

1. A radio receiver comprising an AM antenna receiving an AM radio wave and a receiving semiconductor integrated circuit for reception of the AM radio wave,
wherein the receiving semiconductor integrated circuit comprises:
one pad;
a differential amplifying circuit connected to the one pad to amplify an AM radio wave signal received by the AM antenna;
a resistor connected between two input terminals of the differential amplifying circuit; and
a capacitor connected between the resistor and ground and in series with the resistor and ground.

2. The radio receiver according to claim 1, further comprising a coupling capacitor between the AM antenna and the one pad.

3. A radio receiver comprising an AM antenna receiving an AM radio wave, a receiving semiconductor integrated circuit for reception of the AM radio wave, and a coupling capacitor connected between the AM antenna and one pad of the receiving semiconductor integrated circuit,
wherein the receiving semiconductor integrated circuit comprises:
a differential amplifying circuit connected to the one pad to amplify an AM radio wave signal received by the AM antenna; and
a resistor connected between two input terminals of the differential amplifying circuit.

4. The radio receiver according to claim 1, wherein the differential amplifying circuit comprises a MOS transistor.

5. The radio receiver according to claim 3, wherein the differential amplifying circuit comprises a MOS transistor.

6. A receiving semiconductor integrated circuit comprising:
a differential amplifying circuit connected to one pad to amplify an AM radio wave signal received by an AM antenna;
a resistor connected between two input terminals of the differential amplifying circuit; and
a capacitor connected between the resistor and ground and in series with the resistor and ground.

7. The receiving semiconductor integrated circuit according to claim 6, wherein the differential amplifying circuit comprises a MOS transistor.
